(19) United States
(12) Patent Application Publication
(10) Pub. No.: US 2002/0078362 A1
(43) Pub. Date: Jun. 20, 2002

(54) Security system

(75) Inventor: Hiroyuki Matsui, Gunma (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/021,051

(22) Filed: Dec. 19, 2001

(30) Foreign Application Priority Data
Dec. 20, 2000 (JP) 2000-386816

(51) Int. Cl. H04K 1/00

(52) U.S. Cl. 713/185

(57) ABSTRACT

A security system is provided that can prevent a computer in operation to be used illegally. When judging that an ID code matching an ID code stored in the ID information holder 101 is not received and that the time period measured by the time measurer 106 exceeds a predetermined value, the controller 107 ends the operating system working in the PC 100.

### BACKGROUND OF THE INVENTION

The present invention relates to a security system that can prevent a computer in operation from being used illegally.

In present days where LANS, Internets, and the like are broadly being used, it is strongly wanted to retain the security of data handled on the network. With the advance of a worldwide information network such as the Internet, a criminal illegal act where “who”, “when”, and “where” cannot be specified is spreading. In order to deal with such criminal acts, various security countermeasures have been considered and proposed.

For instance, security is basically retained by using a user ID (identifier) or a password to identify the user which has access to a computer linked to a network or to leave an access log, while an illegal use of the information system is prevented. In a more sophisticated security retaining method, a firewall is provided at the gate for an access to a computer to prevent an illegal access from the outside or a leakage of information from the inside.

In the stand-alone computer system, an ID and a password, issued to a user authorized in the computer use, are managed so that destruction, falsification, and leakage of data due to an illegal use is prevented. Alternatively, each user may have an access right to a file or directory in such way that only the specific user can access important data.

However, when a normal user does not temporarily seated in front of a computer in a usable mode, a third person can use it. In such a case, such an unauthorized person may have an illegal access to important data, thus causing destruction, falsification, and leakage of data.

### SUMMARY OF THE INVENTION

The present invention is made to solve the above-mentioned problems. An object of the present invention is to provide a security system capable of preventing a personal computer in operation from being used illegally.

According to the present invention, a security system comprises a personal computer (PC) and a portable terminal. The personal computer includes a PC's side ID information holder for storing an ID code to identify a user; a PC's side transmitter/receiver for radio transmitting an ID code stored in the ID information holder and receiving a transmitted ID code; a collator f or collating the ID code received by the PC's side transmitter/receiver with the ID code stored in the PC's side ID information holder; and a controller for controlling the operation of an operating system working in said personal computer. The portable terminal includes a terminal's side ID information holder for storing the ID code; a terminal's side transmitter/receiver for receiving an ID code radio transmitted by the PC's side transmitter/receiver and radio transmitting an ID code stored in the terminal's side ID information holder; and a terminal's side collator for collating an ID code received by the terminal's side transmitter/receiver with an ID code stored in the terminal's side ID information holder. The PC's side transmitter/receiver and the terminal's side transmitter/receiver each have a radio transmission output power with which the ID code cannot be transmitted over a distance where the status of the personal computer can be visually ascertained from the position of the terminal's side transmitter/receiver. When the PC's side transmitter/receiver cannot receive an ID code matching the ID code stored in the PC's side ID information holder through collation of the collator within a predetermined time period after radio transmission of the ID code, the controller ends or interrupts the operation of the operating system working in the personal computer. At the portable terminal, when the terminal's side collator finds that an ID code received by the terminal's side transmitter/receiver matches an ID code stored in the terminal's side information holder, the terminal's side transmitter/receiver radio transmits an ID code stored in the terminal's side ID information holder.

According to the present invention, when the terminal's side receiver at a place over the distance where the status of a personal computer cannot be visually ascertained stays more than a predetermined period of time, the personal computer ends or interrupts its operation.

In the security system of the present invention, the personal computer comprises a PC's side encipherer for encoding an ID code stored in the PC's side ID information holder; and a PC's side decoder for decoding a ciphered ID code received by said PC transmitter/receiver. The portable terminal comprises a terminal's side encipherer for ciphering an ID code stored in the terminal's side ID information holder; and a terminal's side decoder for decoding an ciphered ID code received by the terminal's transmitter/receiver. The PC's side transmitter/receiver radio transmits an ID code ciphered by the PC's side enchiperer. The PC's side collator collates an ID code decoded by the PC's side decoder with an ID code stored in the PC's side ID information holder. The terminal's collator collates an ID code decoded by the terminal's side decoder with an ID code stored in the terminal's side ID information holder. The terminal's side transmitter/receiver radio transmits an ID code ciphered by the terminal's side encipherer.

In another aspect of the invention, a security system comprises a personal computer (PC); and a portable terminal. The personal computer includes a PC's side ID information holder for storing an ID code to identify a user; a PC's side transmitter/receiver for radio transmitting an ID code stored in the ID information holder and receiving a transmitted ID code; a collator for collating the ID code received by the PC's side transmitter/receiver with the ID code stored in the PC's side ID information holder; and a controller for controlling the operation of an operating system working in the personal computer. The personal terminal includes a terminal's side transmitter/receiver for receiving an ID code radio transmitted by the PC's side transmitter/receiver and radio transmitting the ID code. The PC's side transmitter/receiver and the terminal's side transmitter/receiver each have a radio transmission output power with which the ID code cannot be transmitted over a distance where the status of the personal computer can be visually ascertained from the position of the terminal's side transmitter/receiver. When the PC's side transmitter/receiver cannot receive an ID code matching the ID code stored in the PC's side ID information holder through collation of the collator within a predetermined time period after radio transmission of the ID code, the controller ends or interrupts the operation of the operating system working in the personal computer.

In further another aspect of the present invention, a security system comprises a personal computer (PC); and a portable terminal. The personal computer includes a PC's side ID information holder for storing an ID code to identify a user; a PC's side transmitter/receiver for radio transmitting a request signal which requests radio-transmission of an ID code and for receiving a transmitted ID code; a collator for collating the ID code received by the PC's side transmitter/receiver with the ID code stored in the PC's side ID information holder; and a controller for controlling the operation of an operating system working in the personal computer. said personal terminal includes a terminal's side ID information holder for storing the ID code; and a terminal's side transmitter/receiver for receiving the request signal radio transmitted by the PC's side transmitter/receiver and radio transmitting the ID code stored in the terminal's ID information holder in response to the request signal. The PC's side transmitter/receiver has a radio transmission power with which the request signal cannot be transmitted over a distance where the status of the personal computer can be visually ascertained from the position of the terminal's side transmitter/receiver and the terminal's side transmitter/receiver has a radio transmission output power with which the ID code cannot be transmitted over a distance where the status of the personal computer can be visually ascertained from the position of the terminal's side transmitter/receiver. When the PC's side transmitter/receiver cannot receive an ID code matching the ID code stored in the PC's side ID information holder through collation of the collator within a predetermined time period after radio transmission of the request signal, the controller ends or interrupts the operation of the operating system working in the personal computer.

### BRIEF DESCRIPTION OF THE DRAWINGS

This and other objects, features and advantages of the present invention will become more apparent from the following detailed description taken in conjunction with the attached drawings, in which:

FIG. 1 is a schematic diagram illustrating the configuration of a security system according to an embodiment of the present invention; and

FIG. 2 is a flowchart explaining the operation of the security system shown in FIG. 1.

### DESCRIPTION OF THE EMBODIMENTS

A security system according to an embodiment of the present invention will be described below by referring to the attached drawings.

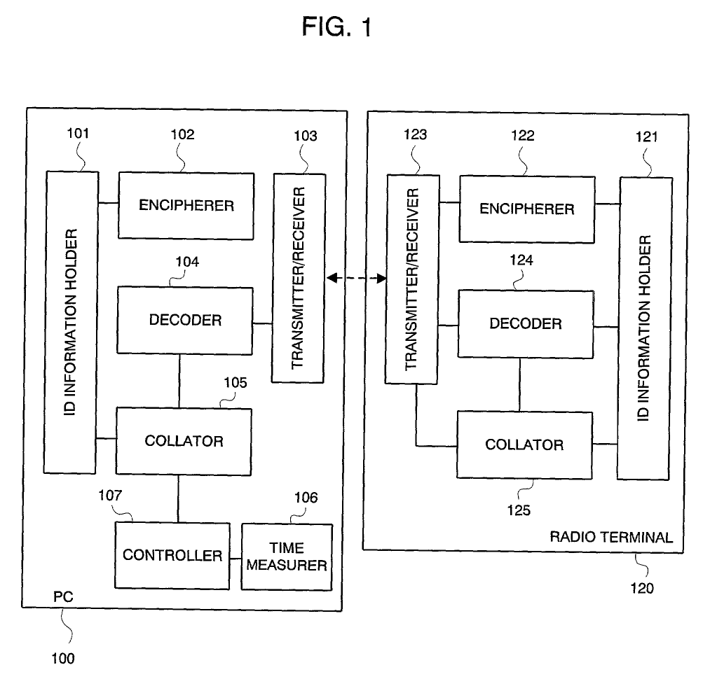

FIG. 1 is a schematic diagram illustrating the configuration of a security system according to an embodiment of the present invention. The security system consists of a personal computer (PC) 100 and a radio terminal 120 having the main function of a portable telephone or a PHS (Personal Handy-phone System). The PC 100 includes an ID information holder 101 for storing an ID (identifier) code, an encipherer 102 for ciphering an ID code stored in the ID information holder 101, and a transmitter/receiver 103 for transmitting an ID code ciphered by the encipherer 102.

The PC 100 further includes a decoder 104 for decoding an ID code received by the transmitter/receiver 103, a collator 105 for collating an ID code decoded by the decoder 104 with an ID code stored in the ID information holder 101 to authenticate a received ID code; a time measurer 106 for measuring a time; and a controller 107 for controlling the PC 100 to halt its operation.

After the transmitter/receiver 103 transmits an ID code, the controller 107 displays a message until the transmitter/receiver 103 receives a matching ID code. When the matching ID code is not received even after the time period measured by the time measurer 106 exceeds a predetermined value, the controller 107 halts the operation of the PC 100. The PC 100 includes general computer elements (not shown), for instance, a CPU, a main memory, a fixed disk unit, a display, and others.

The radio terminal 120 includes an ID information holder 121 for storing an ID code, an encipherer for ciphering an ID code stored in the ID information holder 121, a transmitter/receiver 123 for transmitting an ID code ciphered by the encipherer 122, a decoder 124 for decoding an ID code received by the transmitter/receiver 123, and a collator 105 for collating an ID code decoded by the decoder 124 with an ID code stored in the ID information holder 121 and thus authenticating the received ID code. When the collator 105 authenticates the received ID code, the transmitter/receiver 123 transmits an ID code ciphered by the encipherer 122.

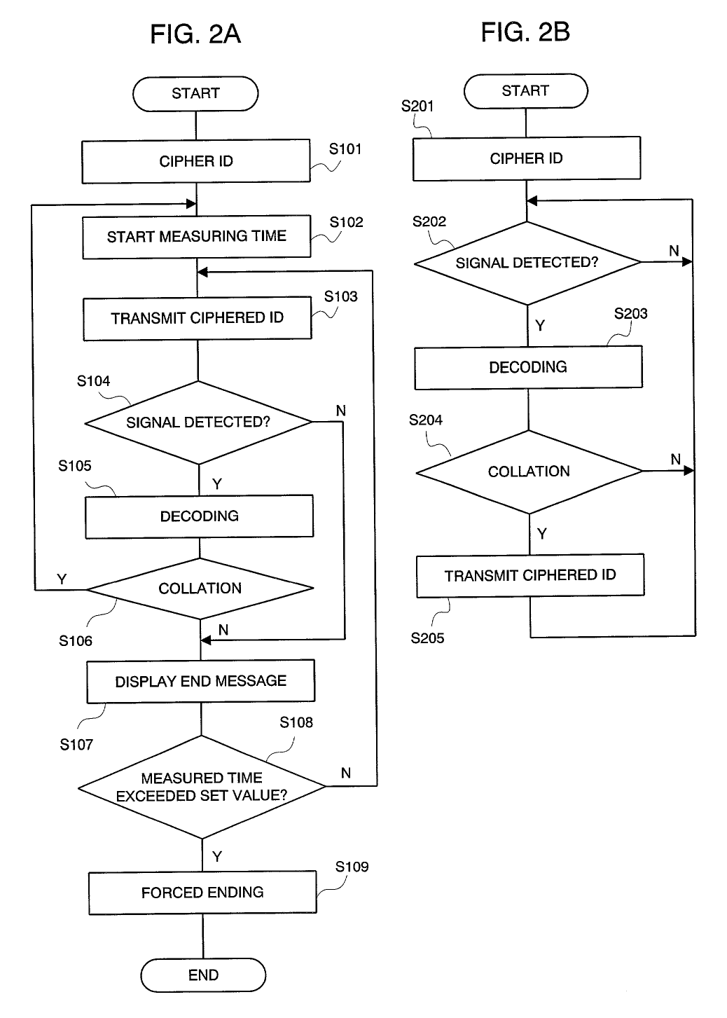

The operation of the security system in FIG. 1 will be described below by referring to the flowchart in FIG. 2.

At the beginning of the operation of the security system, the encipherer 102 in the PC 100 first ciphers an ID code stored in the ID information holder 101 (step S101). Next, the time measurer 106 initializes a current measuring result and then starts measuring a time (step S102). The transmitter/receiver 103 transmits the ciphered ID code (ciphered ID) (step S103). The transmitter/receiver 103 transmits the ciphered ID with a feeble output power with which radio waves can propagate up to a visible range, for example, 2 meter in diameter.

When the ciphered ID is transmitted, the transmitter/receiver 103 starts detecting a signal (acknowledgement) (step S104). In the step S104, when the transmitter/receiver 103 receives the acknowledgement, the decoder 104 decodes the acknowledgement into the decoded information. Thus, the transmitter/receiver 103 checks comparatively the decoded information against the ID code stored in the ID information holder 101 (step S106). In this collation process, when the decoded information matches the ID code, the flow goes back to the step S102.

When the collator 105 finds that the decoded information does not match the ID code (step S106), the controller 107 controls the display (not shown) of the PC 100 to display a forced termination warning, for example, a message of “the system will be forcibly terminated after 10 seconds” (step S107). When acknowledgement is not detected in the step S104, the flow goes to the step S107. The warning indicating forced termination is displayed.

Next, the controller 107 judges whether or not the time period measured by the time measurer 106 has exceeded a predetermined value (step S108). When the time period measured by the time measurer 106 has exceeded the predetermined value, the controller 107 terminates the operating system working in the PC 100 (step S109). In contrast, when it is judged that the time period measured by the time measurer 106 has not exceeded the predetermined value in the step S108, the flow goes back to the step S103. Then, the process covering the steps S103 to S107 is repeated.

In the radio terminal 120, the enciperer 122 cipers an ID code stored in the ID information holder 121. Next, the transmitter/receiver 123 starts detecting (receiving) an cipered ID code transmitted from the PC 100 (step S202). When receiving the signal, the transmitter/receiver 123 decodes the signal received by the decoder 124 (step S203) and comparatively checks the signal (code) decoded by the collator 125 against the ID code stored in the ID information holder 121 (step S204).

When the collation proves that the received and decoded code matches the ID code stored in the ID information holder 121, the transmitter/receiver 123 transmits the ID code ciphered in the step S201. When the transmitter/receiver 103 in the PC 100 normally receives the signal transmitted because of matching, the signal is authenticated through the checking in the step S106. Hence, it does not occur that the PC 100 moves to the step S109.

If the ciphered ID code transmitted in the step S103 is received in the step S202, the received and decoded code matches the ID code stored in the ID information holder 121 through the checking in the step S204. With the collation in the step S204 in the radio terminal 120, when the decoded code does not match the ID code, the radio terminal 120 returns to the step S202 and continues the signal detection, thus repeating the following steps.

In the PC 100, the transmitter/receiver 103 may transmit an ID code request signal. In the radio terminal 120, the transmitter/receiver 203 may transmit a ciphered ID code, in response to the request signal. The ID code is transmitted after ciphering and decoded after receiving. However, the ID code may be transmitted without ciphering and may be collated without decoding after reception. The radio terminal 120 may send back the received ciphered ID without collation after reception of the ciphered ID.

In the above-mentioned operation, when a matching ID code is not received after a predetermined period of time, the PC 100 (FIG. 1) forcibly terminates the operating system working in the system S109 (FIG. 2). However, the present invention is not limited to only the present embodiment. The PC 100 may become a halt state in the step S109. In the halt state, the PC 100 restores to a pre-halt state by inputting a certain signal to the input section (not shown) of the PC 100.

In that case, when receiving a signal in a halt state, the PC 100 does not restore completely. However, the PC 100 may restore to the state enabling the operation in the steps S104 to S106 in FIG. 2A and may restore completely the state only when the collation is authenticated in the step S106. This operation allows the security system to maintain its initial state even in the step S109 after an erroneous operation of the security system. Moreover, since only the user having the radio terminal 120 can restore the security system to the initial state, security can be fully retained even in the halt state.

In the present security system, the radio terminal 120 in FIG. 1 is built in a portable telephone, PHS, or the like. However, the telephone number of a portable telephone, PHS, or the like may be used as an ID code. With the PC 100 connected to the public telephone line through an interface such as a modem or through the calling from the portable telephone, the terminating PC 100 can control the ID information holder 101 to store as an ID code the telephone number of the personal telephone at a call origination.

As described above, according to the present invention, when a portable terminal, for example, a portable telephone or PHS, leaves away from a personal computer in a use state over a predetermined distance, the security system starts its operation. As a result, the personal computer is terminated or interrupted after a predetermined period of time. Therefore, the security system of the present invention has the advantage in that a personal computer in a working state can be prevented from an illegal use.

The entire disclosure of Japanese Application No. 2000-386816 filed Dec. 20, 2000 including specification, claims, drawings and summary are incorporated herein by reference in its entirely.

What is claimed is:

1. A security system comprising:
a personal computer (PC); and
a portable terminal;
said personal computer including:
a PC's side ID information holder for storing an ID code to identify a user;
a PC's side transmitter/receiver for radio transmitting an ID code stored in said ID information holder and receiving a transmitted ID code;
a collator for collating the ID code received by said PC's side transmitter/receiver with the ID code stored in said PC's side ID information holder; and
a controller for controlling the operation of an operating system working in said personal computer
said portable terminal including:
a terminal's side ID information holder for storing said ID code;
a terminal's side transmitter/receiver for receiving an ID code radio transmitted by said PC's side transmitter/receiver and radio transmitting an ID code stored in said terminal's side ID information holder; and
a terminal's side collator for collating an ID code received by said terminal's side transmitter/receiver with an ID code stored in said terminal's side ID information holder;
wherein said PC's side transmitter/receiver and said terminal's side transmitter/receiver each have a radio transmission output power with which said ID code cannot be transmitted over a distance where the status of said personal computer can be visually ascertained from the position of said terminal's side transmitter/receiver;
wherein when said PC's side transmitter/receiver cannot receive an ID code matching the ID code stored in said PC's side ID information holder through collation of said collator within a predetermined time period after radio transmission of said ID code, said controller ends the operation of the operating system working in said personal computer;
wherein, at said portable terminal, when said terminal's side collator finds that an ID code received by said terminal's side transmitter/receiver matches an ID code stored in said terminal's side information holder, said terminal's side transmitter/receiver radio transmits an ID code stored in said terminal's side ID information holder.

2. The security system defined in claim 1, wherein said personal computer comprises:
a PC's side encipherer for encoding an ID code stored in said PC's side ID information holder; and
a PC's side decoder for decoding a ciphered ID code received by said PC transmitter/receiver;
said portable terminal comprises:
a terminal's side encipherer for ciphering an ID code stored in said terminal's side ID information holder; and
a terminal's side decoder for decoding an ciphered ID code received by said terminal's transmitter/receiver;
wherein said PC's side transmitter/receiver radio transmits an ID code ciphered by said PC's side enchiperer;
wherein said PC's side collator collates an ID code decoded by said PC's side decoder with an ID code stored in said PC's side ID information holder;
wherein said terminal's collator collates an ID code decoded by said terminal's side decoder with an ID code stored in said terminal's side ID information holder; and
wherein said terminal's side transmitter/receiver radio transmits an ID code ciphered by said terminal's side encipherer.

3. A security system comprising:
a personal computer (PC); and
a portable terminal;
said personal computer including:
a PC's side ID information holder for storing an ID code to identify a user;
a PC's side transmitter/receiver for radio transmitting an ID code stored in said ID information holder and receiving a transmitted ID code;
a collator for collating the ID code received by said PC's side transmitter/receiver with the ID code stored in said PC's side ID information holder; and
a controller for controlling the operation of an operating system working in said personal computer said portable terminal including:
a terminal's side ID information holder for storing said ID code;
a terminal's side transmitter/receiver for receiving an ID code radio transmitted by said PC's side transmitter/receiver and radio transmitting an ID code stored in said terminal's side ID information holder; and
a terminal's side collator for collating an ID code received by said terminal's side transmitter/receiver with an ID code stored in said terminal's side ID information holder;
wherein said PC's side transmitter/receiver and said terminal's side transmitter/receiver each have a radio transmission output power with which said ID code cannot be transmitted over a distance where the status of said personal computer can be visually ascertained from the position of said terminal's side transmitter/receiver;
wherein when said PC's side transmitter/receiver cannot receive an ID code matching the ID code stored in said PC's side ID information holder through collation of said collator within a predetermined time period after radio transmission of said ID code, said controller interrupts the operation of the operating system working in said personal computer;
wherein, at said portable terminal, when said terminal's side collator finds that an ID code received by said terminal's side transmitter/receiver matches an ID code stored in said terminal's side information holder, said terminal's side transmitter/receiver radio transmits an ID code stored in said terminal's side ID information holder.

4. The security system defined in claim 3, wherein said personal computer comprises:
a PC's side encipherer for encoding an ID code stored in said PC's side ID information holder; and
a PC's side decoder for decoding a ciphered ID code received by said PC transmitter/receiver;
said portable terminal comprises:
a terminal's side encipherer for ciphering an ID code stored in said terminal's side ID information holder; and
a terminal's side decoder for decoding an ciphered ID code received by said terminal's transmitter/receiver;
wherein said PC's side transmitter/receiver radio transmits an ID code ciphered by said PC's side enchiperer;
wherein said PC's side collator collates an ID code decoded by said PC's side decoder with an ID code stored in said PC's side ID information holder;
wherein said terminal's collator collates an ID code decoded by said terminal's side decoder with an ID code stored in said terminal's side ID information holder; and
wherein said terminal's side transmitter/receiver radio transmits an ID code ciphered by said terminal's side encipherer.

5. A security system comprising:
a personal computer (PC); and
a portable terminal;
said personal computer including:
a PC's side ID information holder for storing an ID code to identify a user;
a PC's side transmitter/receiver for radio transmitting an ID code stored in said ID information holder and receiving a transmitted ID code;
a collator for collating the ID code received by said PC's side transmitter/receiver with the ID code stored in said PC's side ID information holder; and
a controller for controlling the operation of an operating system working in said personal computer;
said personal terminal including:
a terminal's side transmitter/receiver for receiving an ID code radio transmitted by said PC'S side transmitter/receiver and radio transmitting said ID code;
wherein said PC's side transmitter/receiver and said terminal's side transmitter/receiver each have a radio transmission output power with which said ID code cannot be transmitted over a distance where the status of said personal computer can be visually ascertained from the position of said terminal's side transmitter/receiver;
wherein when said PC's side transmitter/receiver cannot receive an ID code matching the ID code stored in said PC's side ID information holder through collation of said collator within a predetermined time period after radio transmission of said ID code, said controller ends the operation of the operating system working in said personal computer.

6. A security system comprising:
a personal computer (PC); and
a portable terminal;
said personal computer including:
a PC's side ID information holder for storing an ID code to identify a user;
a PC's side transmitter/receiver for radio transmitting an ID code stored in said ID information holder and receiving a transmitted ID code;
a collator for collating the ID code received by said PC's side transmitter/receiver with the ID code stored in said PC's side ID information holder; and
a controller for controlling the operation of an operating system working in said personal computer said personal terminal including:
a terminal's side transmitter/receiver for receiving an ID code radio transmitted by said PC's side transmitter/receiver and radio transmitting said ID code;
wherein said PC's side transmitter/receiver and said terminal's side transmitter/receiver each have a radio transmission output power with which said ID code cannot be transmitted over a distance where the status of said personal computer can be visually ascertained from the position of said terminal's side transmitter/receiver;
wherein when said PC's side transmitter/receiver cannot receive an ID code matching the ID code stored in said PC's side ID information holder through collation of said collator within a predetermined time period after radio transmission of said ID code, said controller interrupts the operation of the operating system working in said personal computer.

7. A security system comprising:
a personal computer (PC); and
a portable terminal;
said personal computer including:
a PC's side ID information holder for storing an ID code to identify a user;
a PC's side transmitter/receiver for radio transmitting a request signal which requests radio-transmission of an ID code and for receiving a transmitted ID code;
a collator for collating the ID code received by said PC's side transmitter/receiver with the ID code stored in said PC's side ID information holder; and
a controller for controlling the operation of an operating system working in said personal computer
said personal terminal including:
a terminal's side ID information holder for storing said ID code; and
a terminal's side transmitter/receiver for receiving said request signal radio transmitted by said PC's side transmitter/receiver and radio transmitting said ID code stored in said terminal's ID information holder in response to said request signal;
wherein said PC's side transmitter/receiver has a radio transmission power with which said request signal cannot be transmitted over a distance where the status of said personal computer can be visually ascertained from the position of said terminal's side transmitter/receiver and said terminal 's side transmitter/receiver has a radio transmission output power with which said ID code cannot be transmitted over a distance where the status of said personal computer can be visually ascertained from the position of said terminal's side transmitter/receiver;
wherein when said PC's side transmitter/receiver cannot receive an ID code matching the ID code stored in said PC's side ID information holder through collation of said collator within a predetermined time period after radio transmission of said request signal, said controller ends the operation of the operating system working in said personal computer.

8. A security system comprising:
a personal computer (PC); and
a portable terminal;
said personal computer including:
a PC's side ID information holder for storing an ID code to identify a user;
a PC's side transmitter/receiver for radio transmitting a request signal which requests radio-transmission of an ID code and for receiving a transmitted ID code;
a collator for collating the ID code received by said PC's side transmitter/receiver with the ID code stored in said PC's side ID information holder; and
a controller for controlling the operation of an operating system working in said personal computer said personal terminal including:
a terminal's side ID information holder for storing said ID code; and
a terminal's side transmitter/receiver for receiving said request signal radio transmitted by said PC's side transmitter/receiver and radio transmitting said ID code stored in said terminal's ID information holder in response to said request signal;
wherein said PC's side transmitter/receiver has a radio transmission power with which said request signal cannot be transmitted over a distance where the status of said personal computer can be visually ascertained from the position of said terminal's side transmitter/receiver and said terminal's side transmitter/receiver has a radio transmission output power with which said ID code cannot be transmitted over a distance where the status of said personal computer can be visually ascertained from the position of said terminal's side transmitter/receiver;
wherein when said PC's side transmitter/receiver cannot receive an ID code matching the ID code stored in said PC's side ID information holder through collation of said collator within a predetermined time period after radio transmission of said request signal, said controller interrupts the operation of the operating system working in said personal computer.
